(19) United States
(12) Patent Application Publication
(10) Pub. No.: US 2010/0077639 A1
(43) Pub. Date: Apr. 1, 2010

(54) GREETING SIGN

(76) Inventor: CLAIRE GENEVIEVE LUWAERT, Asheville, NC (US)

Correspondence Address: Claire Luwaert, 5 Elmore Street, Ashville, NC, 28804, US

(21) Appl. No.: 12/564,260

(22) Filed: Sep. 22, 2009

Related U.S. Application Data
(60) Provisional application No. 61/100,026, filed on Sep. 25, 2008.

(51) Int. Cl. G09F 1/00; G09F 7/12; G09F 7/22

(52) U.S. Cl. 40/124.01; 40/594

(57) ABSTRACT

The present invention combines the greeting message feature and the customary mailing feature of a greeting card with the display feature of a decorative wall sign. A greeting sign is a semi-rigid card that shows a decorative, inspirational or typographic attribute on its front and a space for a personal message on its back. It features a hanging wire element similar to a decorative wall sign. It can be shipped to the recipient like a greeting card and displayed by the recipient like a wall sign.

### REFERENCE TO RELATED APPLICATION

This applications claims priority benefit of Provisional U.S. patent application Ser. No. 61/100,026, filed Sep. 25, 2008, which is incorporated herein by reference in its entirety.

### BACKGROUND OF THE INVENTION

In this digital age, decorative wall signs that personalize homes and convey personal or inspirational messages are very popular. However, due to their format and/or weight they are not designed to be either displayed in commerce or shipped by a consumer as a gift to friends and family in a manner that is either user-friendly or economical. Wall signs are also not designed to be conveniently personalized due to their chosen material, traditionally clay or wood. Greeting cards are often used as keepsakes by the recipient, due to their emotional value but are not designed to be displayed on a wall without additional work, time investment and expense on the part of the end user. Very often the card is put in a drawer, never to be displayed again due to time constraints. From a merchandising point of view, while a greeting card is cost-efficient in terms of required square footage and shipping costs, a decorative wall sign is not, due to the bulky and often expensive displays required to offer the item for sale. With this consideration, a product that bridges the gap between the greeting card and gift markets would appeal in terms of personalization potential and cost-efficiency to commercial buyers and consumers alike.

### SUMMARY OF THE INVENTION

The invention offers the advantage of inscribing a wall sign that is not traditionally personalized in a convenient manner, to send it with the economy of a greeting card and to have it displayed by the recipient like a decorative wall sign at no additional cost and without delay. From a merchandising perspective, the invention would be welcome as an economical way to offer an inspirational sign at a fraction of the cost generally associated with such items. An exemplary embodiment of the invention herein disclosed is a flat body made of a thick yet flexible material such as cardstock. The flat body component includes a front portion that displays the inspirational or decorative attribute and a rear portion that allows the consumer to write a personal message. The hanging wire element is attached to the top of the rear portion of the flat body by an adhesive agent. The adhesive is then covered by a strip of printed material that displays product information. The inscribed greeting sign is then inserted into the provided envelope with the provided protective card element that allows the recipient to receive the greeting sign without damage that might incur during conveyance.

### BRIEF DESCRIPTION OF THE DRAWINGS

The embodiments of the present invention are illustratively shown in the accompanying drawings which depict the principles of the present invention.

FIG. 1 is a plan view of the front surface of one embodiment of the sign part of the present invention.

FIG. 2 is a plan view of the rear surface of one embodiment of the sign part of the present invention.

FIG. 3 is a plan view of the sign part, the protective card part and the envelope part of the present invention, as stacked and unwrapped.

FIG. 4 is a plan view of the sign part, the protective card part and the envelope part of the present invention, as spread out and unwrapped.

FIG. 5 is a plan view of the front surface of a horizontal embodiment of the sign part of the present invention.

FIG. 6 is a plan view of the rear surface of a horizontal embodiment of the sign part of the present invention.

FIG. 7 is a plan view of the sign part, the protective card part and the envelope part of the horizontal embodiment of the present invention, as stacked and unwrapped.

FIG. 8 is a plan view of the sign part, the protective card part and the envelope part of the horizontal embodiment of the present invention, as spread out and unwrapped.

FIG. 9 illustrates selected steps of a process of using an embodiment of the present invention.

### DETAILED DESCRIPTION OF THE DRAWINGS

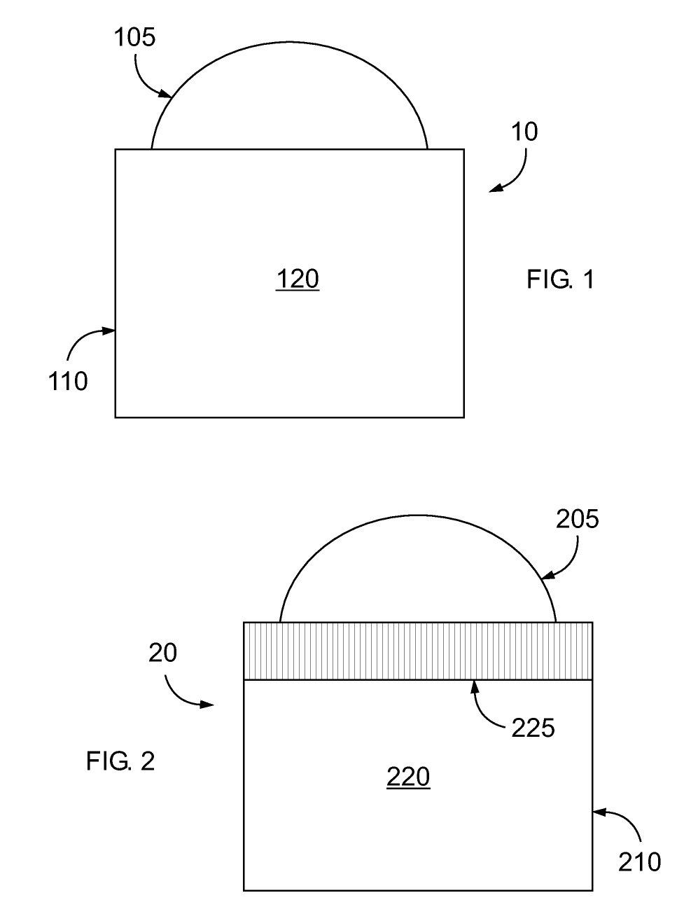

FIG. 1 illustrates a flat frontal view of the sign part 10 of the invention, comprised of a unitary sheet of material 110 and a wire 105. The front body of the sign 10 conveys in 120 its inspirational or decorative attribute.

FIG. 2 illustrates a flat rear view of the sign part 20 of the invention, comprised of the rear of the unitary sheet of material 210 shown frontally in 110 and the back of the wire 205 shown in 105. The wire is secured by adhesive to the rear body of the sign 210. A strip of material 225 covers the adhesive area and further secures the wire 205 to the body 210. The user's personal message can be inscribed in the writing area 220.

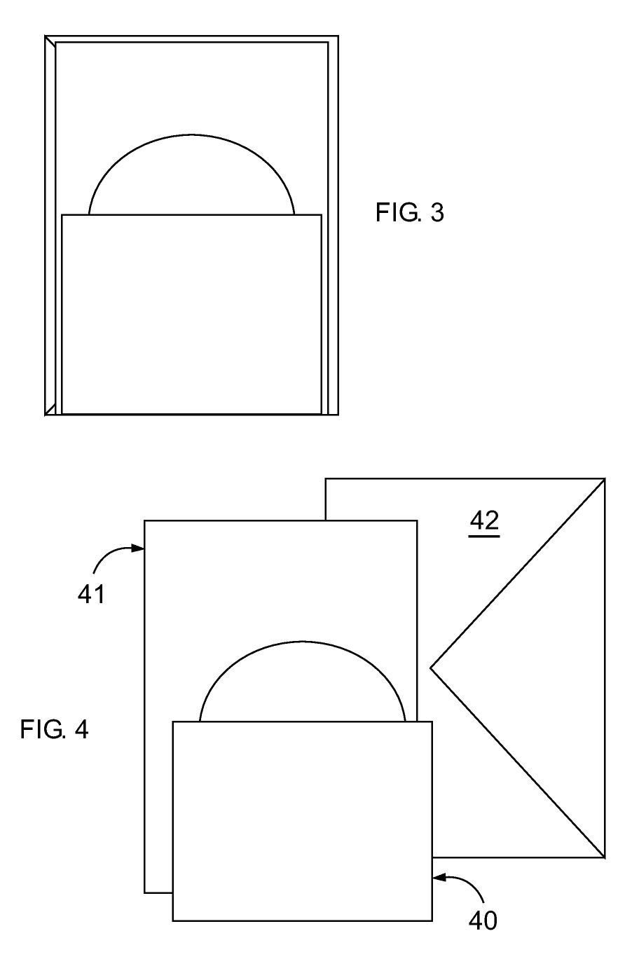

FIG. 3 illustrates a plan view of the complete unwrapped greeting sign, further illustrated in FIG. 4 in a spread view, as comprising the sign 40, a protective card 41 and a mailing envelope 42.

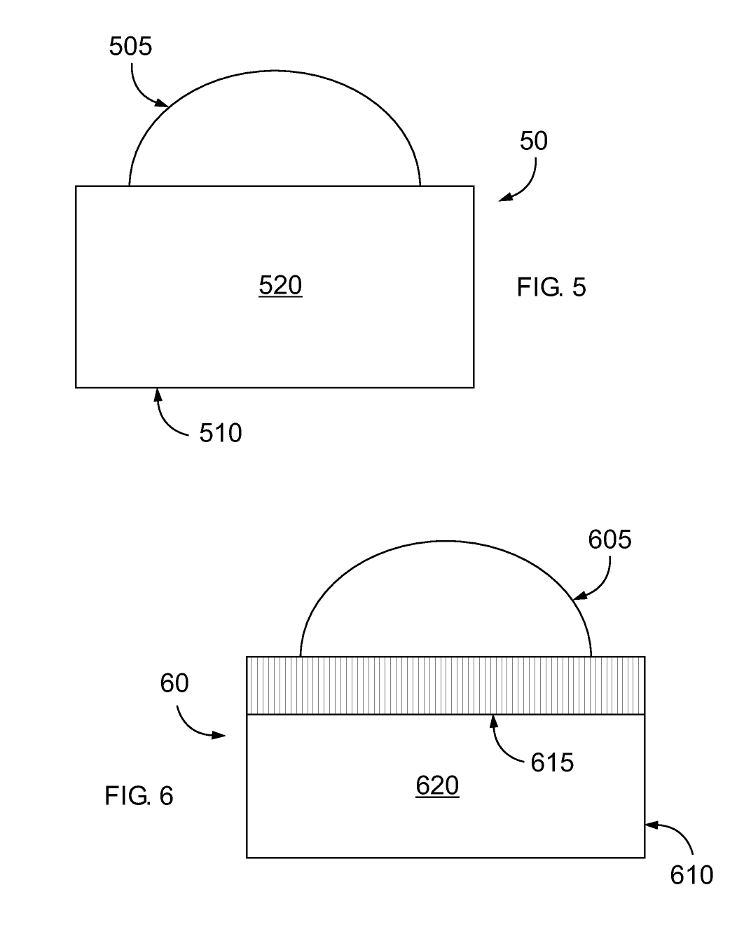

FIG. 5 illustrates a flat frontal view of a horizontal alternative of the sign part 50 of the invention, comprised of a unitary sheet of material 510 and a wire 505. The front body of the sign 50 conveys in 520 its inspirational or decorative attribute.

FIG. 6 illustrates a flat rear view of a horizontal alternative of the sign part 60 of the invention, comprised of the back of the unitary sheet of material 610 shown frontally in 510 and the rear of the wire 605 shown frontally in 505. The wire is secured by adhesive to the rear body of the sign 610. A strip of material 615 covers the adhesive and further secures the wire 605 to the body 610. The user's personal message can be inscribed in the writing area 620.

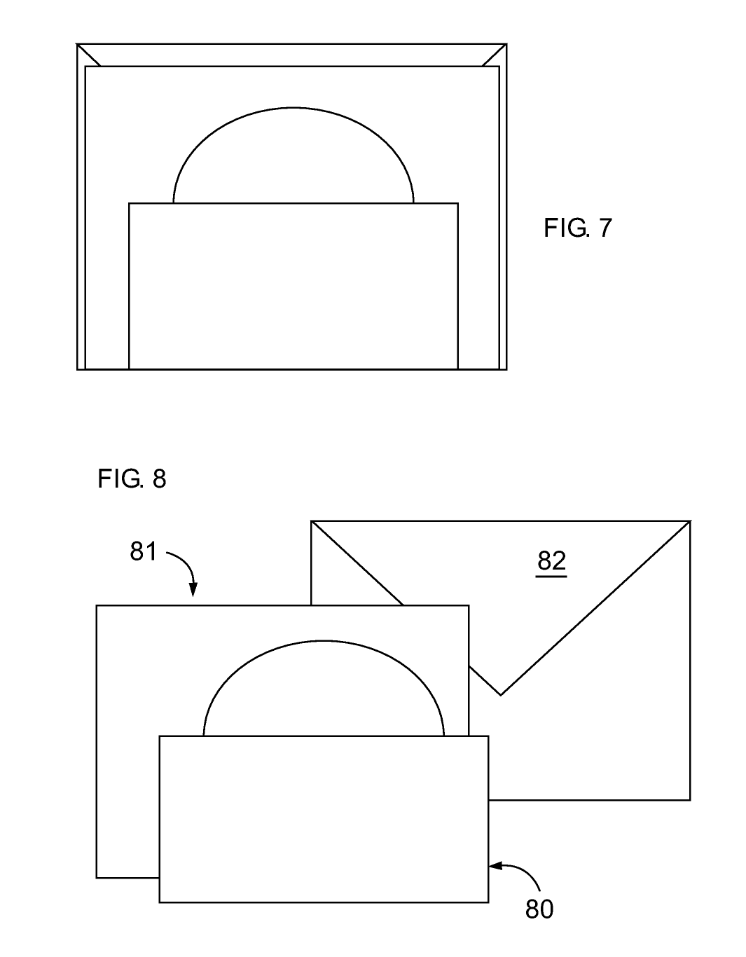

FIG. 7 illustrates a plan view of the complete unwrapped horizontal alternative embodiment of the present invention, further illustrated in FIG. 8 in a spread view, as comprising the sign 80, a protective card 81 and a mailing envelope 82.

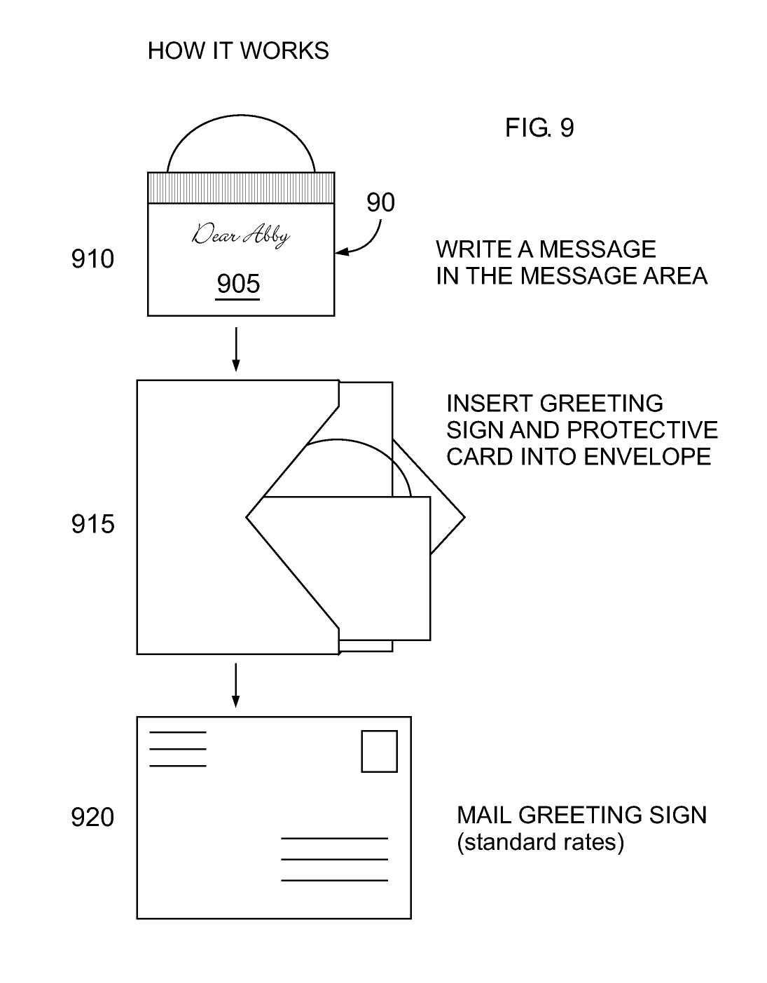

FIG. 9 illustrates selected steps of a process of using an embodiment of the present invention. At step 910, the sign part 90 of the greeting sign is inscribed by the user in the message area 905. At step 915 the sign is inserted with its protective card in the provided envelope. At step 920, the envelope is addressed and stamped by the user, to be mailed to a recipient.

This document describes a wall sign that is used and conveyed as a greeting card while retaining its ability to be displayed as hanging from a vertical surface.

This was done for illustrations purposes only. Neither the specific embodiments of the invention as a whole, not those if its features, limit the general principles underlying the invention. In particular, the invention is not limited to its size, shape, materials used for manufacturing it, the specific configuration of its various elements, or the specific printing technique. Such modifications and variations in these specifications as may occur to those skilled in the art are considered to come within the scope of the following claims.

What is claimed is:

1. A sign comprising:
a flat body cut from a flexible material, the flat body comprising:
a front portion displaying a decorative, inspirational and/or typographic attribute,
a rear portion comprising a message area that can be inscribed by the user; and
a wire that allows the flat body to be displayed hanging; and
an adhesive agent that allows the wire element to be bound to the rear of the flat body of the sign; and
a strip of material that seals in the adhesive and further secures the wire to the body of the sign.

2. Means for presenting a wall sign according to claim 1, comprising in combination the sign, a protective card and an envelope.

3. Means of manufacture allowing for the conveyance of a wall sign according to claim 1 to its end user in the manner of a greeting card, by selection of materials and elements.

4. Means of merchandising a wall sign according to claim 1 in the manner of a greeting card, in a greeting card display fixture or in any format used in the merchandising of a greeting card, by selection of materials and size of the elements.
